(19) United States
(12) Patent Application Publication
(10) Pub. No.: US 2022/0129422 A1
(43) Pub. Date: Apr. 28, 2022

(54) EFFICIENT METHOD TO IDENTIFY CHANGED OBJECTS FOR LARGE SCALE FILE SYSTEM BACKUP

(71) Applicant: EMC IP Holding Company LLC, Hopkinton, MA (US)

(72) Inventors: Andy Li Ke, Chengdu (CN); Michael Smolenski, Sparks, NV (US)

(21) Appl. No.: 17/082,925

(22) Filed: Oct. 28, 2020

(51) Int. Cl. G06F 16/18; G06F 16/11; G06F 16/176; G06F 16/13

(52) U.S. Cl. CPC G06F 16/1873; G06F 16/137; G06F 16/1767; G06F 16/122

(57) ABSTRACT

One example method includes identifying changed objects in a filesystem. Entry lists of a previous backup and a current backup are processed at the same time. The comparison allows objects in the filesystem to be identified as unchanged, modified, new, or deleted relative to a previous backup.

### FIELD OF THE INVENTION

Embodiments of the present invention generally relate to data protection and data protection operations. More particularly, at least some embodiments of the invention relate to systems, hardware, software, computer-readable media, and methods for identifying changed objects in a computing or file system.

### BACKGROUND

Data protection operations such as backup operations are regularly performed in most computing systems. If an entity fails to protect their data, any type of data loss or disaster could prove catastrophic for the entity. Backup operations are often performed in different manners. For example, a data protection system may generate a full backup of an entity's data. After the full backup has been completed, it is often possible to generate incremental backups. An incremental backup contains copies of data that has changed since the most recent backup. Incremental backups are much smaller than full backups.

In order to perform an incremental backup, it is necessary to identify which of the objects have changed since the most recent backup. In one example, changed objects can be identified using hashes. The hash of a current object can be compared to the hash of the object in the most current backup. If the hashes do not match, the object has changed and needs to be backed up.

To identify the changed objects, an agent or client-side hash table may be maintained. The goal of an agent-side hash table is to speed up the comparison process using an efficient lookup operation in a memory-resident hash table. As the number of objects or files grows, this approach begins to consume too much memory. This problem was partially resolved using a paging cache in conjunction with the hash table. The paging cache was organized into a series of pages that could be read on demand and that were loaded using a heuristic loading mechanism.

As the number of objects in a file system increased, the paging cache began to falter and led to cache misses. Cache misses translated into queries to the backup server. This resulted in a situation where backup processes became slower and parallelism on the backup server was reduced. Systems and methods are needed to identify changed objects in systems that include large numbers of objects or files.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a directory structure associated with a previous backup;

FIG. 1B discloses aspects of a directory structure associated with a current backup;

FIG. 2A discloses aspects of a list of entries that result from a deterministic traversal of a previous directory structure;

FIG. 2B discloses aspects of a list of entries that result from a deterministic traversal of a current directory structure;

FIG. 3 discloses aspects of traversing the entry lists associated with a previous backup and a current backup;

FIG. 4 discloses aspects of an entry structure that may be used when identifying changed objects;

FIG. 5 discloses aspects of an entry's next field that may be used during traversal of the entry list to skip certain entries;

FIG. 6 discloses aspects of an entry's parent field and illustrates which entries are parent of children entries in an entry list;

FIG. 7 discloses aspects of a data protection system configured to perform backup operations including identifying changed objects in a file system since a previous backup;

FIG. 8 discloses aspects of a stack associated with a crawler engine that is crawling a file system;

FIG. 9 discloses aspects of an entry engine configured to processing working pairs of entries in associated entry lists;

FIG. 10 discloses aspects of a method for checking entries in an entry list and for determining states of the entries;

FIG. 11 discloses aspects of pseudocode for determining a state of an entry in an entry list;

FIG. 12 discloses aspects of pseudocode for determining a state of an entry in an entry list; and

FIG. 13 discloses aspects of a method for determining a state of an entry in an entry list.

### DETAILED DESCRIPTION OF SOME EXAMPLE EMBODIMENTS

Embodiments of the present invention generally relate to data protection operations. More particularly, at least some embodiments of the invention relate to systems, hardware, software, computer-readable media, and methods for data protection operations including backup operations, restore operations, and operations to identify changed objects to include in a backup operation.

The following discussion discusses objects such as directories and files. Embodiments of the invention, however, are not limited to directories and files, but may be implemented in other file systems or storage structures. In some instances, references to a file can also be applied to a directory and vice versa. For ease of discussion, files and directories may both be referred to as objects. Thus, an object is an instance to be protected and may be a protected file or directory for file-level backups. An entry or an object entry is an object representation that contains object metadata. An entry can be resident in memory or disk. One or more entries may be stored in a file or list.

In general, example embodiments of the invention evaluate objects in a file system and/or metadata thereof at least for the purpose of identifying objects that have changed since a most recent backup (or compared to any previous backup if desired).

Embodiments of the invention deterministically generate an entry for each object in a file system. The entries may be stores as a list of entries. Each entry may include data that uniquely identifies the object. As a result, the entries in this list can be compared to entries in a list associated with a previous backup (e.g., the most recent backup). Because the entries are generated deterministically, the lists can be traversed in parallel and the individual entries in the two lists can be compared to identify objects that have changed. The traversal of the lists is configured such that the traversal accounts for or identifies new objects, modified objects, and deleted objects.

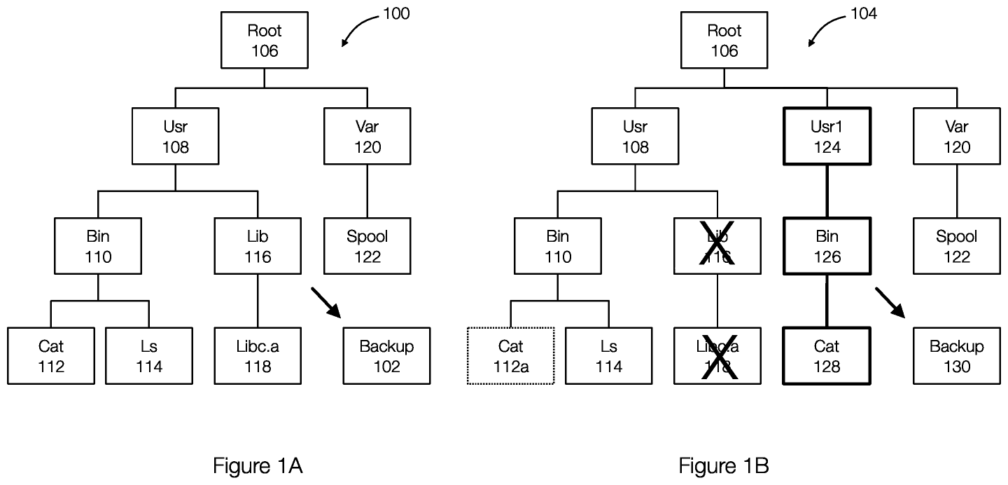

FIG. 1A illustrates aspects of objects in a filesystem associated with a previous backup or a previous point in time and FIG. 1B illustrates aspects of objects in the same filesystem associated with a current backup or a current point in time.

FIG. 1A more specifically illustrates a directory structure 100. The structure 100 (or the data/objects therein) were protected in a backup 102. As illustrated, the structure 100 includes a root object “/” or root 106 that has children objects. Some of the children objects include, by way of example only, directories (e.g., Usr 108, Var 120, Bin 110, Lib 116). Some of the children objects may be files (e.g., Cat 112, Ls 114, Libc.a 118, Spool 122). In this example, the structure 100 represents the file system layout and the objects associated with a previous backup 102. The file system or more specifically, the objects or data in the file system shown in the structure 100 are backed up as the backup 102.

FIG. 1B illustrates a directory structure 104. The structure 104 illustrates the same structure as shown in FIG. 1A, but at a different point in time. The structure 104 may correspond to the same file system represented in FIG. 1A, but at a current time. The structure 104 or data or objects therein are or will be backed up in the backup 130. The backup 130 may be an incremental backup and only store the changes or differences between the structure 104 and the structure 100.

FIG. 1B illustrates some of the changes that have occurred in the file system since the backup 102. For example, the object Cat 112 has been modified (shown in dotted line) and is represented by cat 112a. The objects Lib 116 and Libc.a 118 have been deleted (shown with an “X”). The objects Usr1 124, Bin 126 and Cat 128 are new objects.

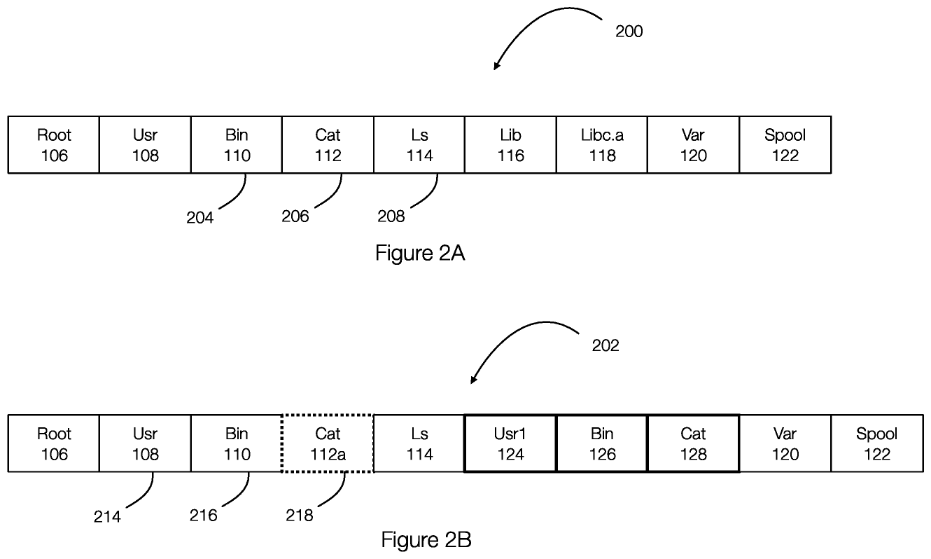

FIG. 2A illustrates a list of entries 200 (organized as a file for example) that result from a deterministic traversal of the directory structure 100. FIG. 2B illustrates a list of entries 202 (also referred to as file 202) that result from a deterministic traversal of the directory structure 104. The list of entries 200 and the list of entries 202 may be represented as a file. The file includes an entry for each object in the corresponding file system. In one example, each entry has a fixed size and all entries are the same size. The entries in the files 200 and 202 correspond to the objects identified inside each of the entries. Thus, the entry root 106 in the list 200 refers to the entry for the object 106.

FIGS. 2A and 2B illustrate that the entries are produced and arranged according to a depth-first traversal of, respectively, the structures 100 and 104. FIG. 2A illustrates that the entries of a parent object and its child objects are arranged together in the depth-first ordered list. For example, in the entry list or file 200, the entry 204 for bin 110 is a parent entry of the entries 206 and 208 for the objects cat 112 and Ls 114. These three entries 204, 206, and 208 in the list 200 stand together with the entries 214, 216 and 218 and in the list 202. The lists 200 and 202 further illustrate that the unchanged or modified objects or entries keep their relative positions between two successive backups. For example, the subsequence root-usr-bin-cat-ls and the sub-sequence var-spool shown in FIGS. 2A and 2B keep their relative positions in the list 200 and in the list 202. The lists 200 and 202 can be traversed in parallel to identify changed objects in the file system. The entries can be processed, in one example, in pairs.

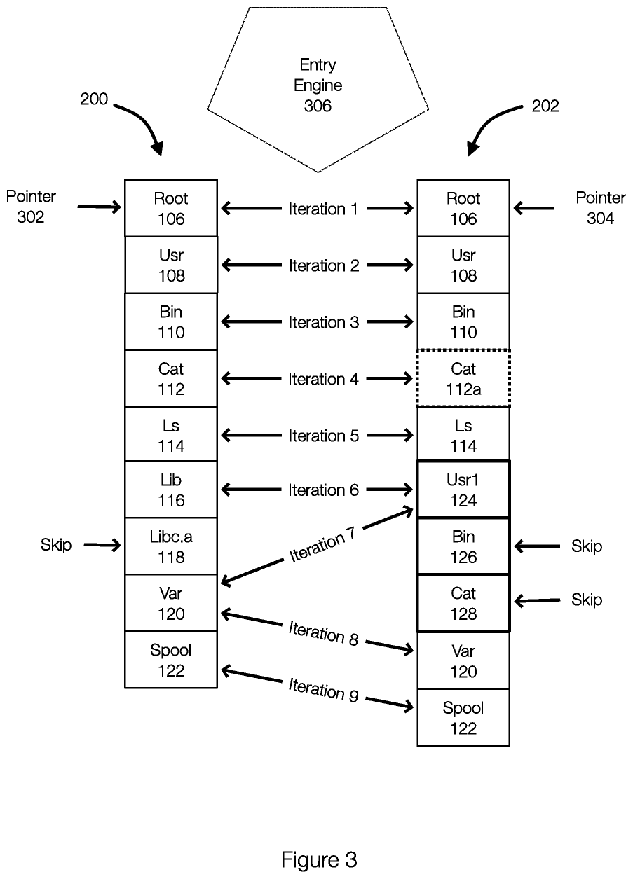

FIG. 3 illustrates an example of an entry engine configured to traverse entry lists to identify objects that have changed relative to a previous backup. FIG. 3 illustrates the lists 200 and 202. An entry engine 306 is configured to traverse the lists 200 and 202 in parallel and compare entries in order to determine whether an object is, for example, new, modified, deleted, or unchanged. The entry engine 306 typically compares entries in pairs—one entry from each of the lists 200 and 202. The entry engine 306, in effect, slides from the first pair of entries in the lists 200 and 202 to the last entries in the lists 200 and 202. This implementation is memory efficient.

When traversing the lists 200 and 202, pointers may be initialized. The pointer 302 points to the first entry (for the object or root 106) in the list 200 and the pointer 304 points to the first entry (for the object or root 106) in the list 202. The entry engine 306 obtains an entry pair (the entries pointed to by the pointers 302 and 304) from the lists 200 and 202. The entry pair may be represented by {previousEntry, currentEntry} or {PList(m), CList (n)}, where PList is the previous entry list 200 and CList is the current entry list 202 and m and n are the entries pointed to by the entry pointers 302 and 304.

As a result, the first iteration (iteration 1) compares the first entries in the lists 200 and 202. The iterations continue (iterations 2, 3, 4, 5, 6, 7, 8, 9) until the last entries in the lists 200 and 202 have been compared or processed. Once the entry engine 306 has completed the traversal of the lists 200 and 202, the changed objects can be identified and can be backed up as necessary. As discussed in more detail herein, an entry may be determined to have been deleted or to have been added. As a result, the entry engine 306 is configured to skip entries in the lists 200 and 202. For example, As illustrated by iteration 6, 7, and 8, the objects that have been deleted (Libc.a 118 in list 200) and the objects that are new (Usr1 124, Bin 126, and Cat 128 in list 202) are skipped. This allows the entry engine 306 to resume comparing entry pairs that are related, as illustrated by the iteration 8. The deterministic traversal of the file system, which results in the lists 200 and 202 such that the relative locations of objects is maintained allows these types of entries (e.g., entries for deleted/new objects) to be skipped while still identifying the objects as new or deleted for backup purposes.

More specifically, as the entry engine 306 performs these iterations, the entry engine 306 may determine that an entry is new or has been deleted. In this case, the entries are skipped and the relevant pointer is updated as needed. For example, performing the iterations or entry comparisons allows the entry engine 306 to determine that the entry for the object lib 116 in the list 200 has been deleted (see FIGS. 1A and 1B) during iteration 6. As a result, the pointer 302 is advanced to the entry for the object var 120 and the entry for the object Libc.a 118 is skipped. Similarly, iterations 6 and 7 allow the entry engine 306 to determine that the object Usr1 is new. As a result, the entries for the new object under that directory (objects bin 126 and cat 128) can be skipped and the pointer 304 can be advanced to point to the entry for the object var 120 in the list 202.

Before discussing how to determine whether objects corresponding to the entries in the lists 200 and 202 relate to objects that are deleted, new, or modified or when to skip entries in the lists, a discussion of the entries in the lists or files 200 and 202 is provided.

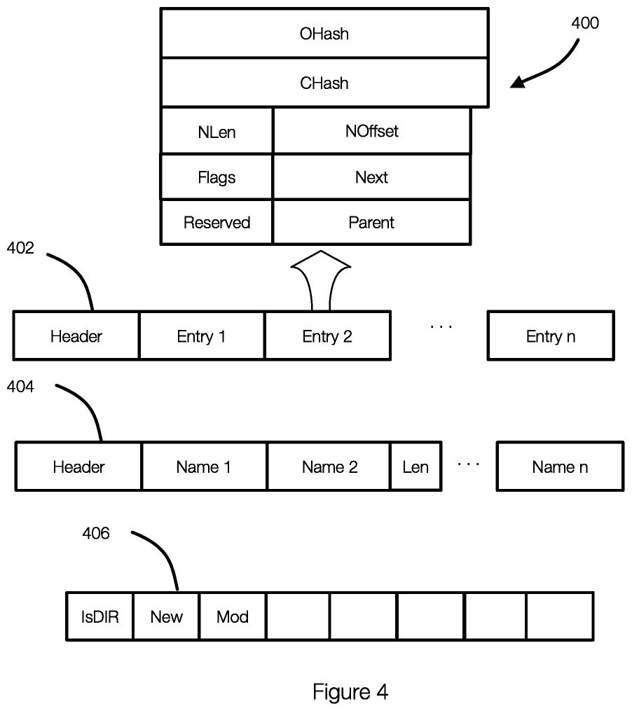

FIG. 4 illustrates structures that may be used when identifying changed objects (e.g., new, modified, deleted). When evaluating a filesystem or when crawling the filesystem in a deterministic manner, a list 402 is generated. The list 402 may be a file with a header and a plurality of entries. Each entry corresponds to an object in the file system. In some examples, a name file 404 may also be generated. These files may be generated each time a backup is performed in one example or each time the file system is crawled or evaluated. These files may be temporary files (e.g., .tmp files) that are generated initially or during a backup operation. After the backup operation is completed, these files (the entry file 402 and the name file 404) for the previous backup may be deleted (e.g., to conserve space). The entry file 402 and the name file 404 for the current backup may be given a different file extension and may be backed up as part of the backup metadata. Similarly, these files or their content may also be included in the metadata of previous backups even if the files themselves are subsequently deleted.

FIG. 4 illustrates that the entry file 402 includes entries (e.g., entry 1, entry 2, . . . entry n). FIG. 4 illustrates an entry 400 in more detail. The entry 400 has a fixed size in one example and may have several fields including at least one or more of OHash, CHash, NLen, NOffset, Flags, Next, Reserved, and Parent fields. The size may depend on which fields are included. Each entry in the entry file 402 has the same configuration in one embodiment.

The following discussion provides a size for each of these fields by way of example only and not limitation. In one example, the OHash field (20 bytes) contains a hash calculated or determined from a combination of the object's full path, the object's size, a modified time, and a hash of the object content. The hash of the content of the corresponding object may be placed in the CHash field. The selection of metadata used to generate the OHash may vary and is not limited to the metadata and combination discussed herein. The metadata is selected such that the OHash is unique to the object and allows a determination to be made regarding the state of the object (e.g., whether the object is new, deleted, modified).

The OHash can be generated without accessing the content of the associated object and can be generated, for example, from metadata. This results in a faster operation to generate the OHash. Further, the entry engine 306 is not required to generate the CHash when crawling the file system and generating the entries in the entry file 402. If the CHash is present or available, the CHash may be place in the CHash field (20 bytes), this indicates, in one example, the existence of a protected object.

The NLen field (1 byte) is used to store a length of the object's names (e.g., number of characters in the name). The NOffset field (7 bytes) stores the offset of the name in the name file 404. NLen and NOffset are used for addressing the object name in the name file.

More specifically, the name file 404 is included in one embodiment in order to account for long filenames. The NLen field is generally used to identify the length of the object's name as previously stated because, typically, the length of a normal file name is less than 255. When the length of the file name exceeds 255, the nLen field is set to zero and an extra length field (Len (2 bytes) in the name file 404) is written at the location indicated by the NOffset field. The Len field in the name file 404 may store the length of the long file name. The long filename is written after the len field in one example.

In one example, the name file 404 may be eliminated if inodes are used instead of file names. More generally, the entry 400 can be adapted to various platforms.

The bits in the flags field (1 byte) are used for various purposes. The first bit (IsDIR) in the flags field 406, may represent whether the object associated with the entry represents a directory or a file. The second bit (New) may represent whether the corresponding object is newly added. The fourth bit (Mod) may represent whether the corresponding object has been modified between backups. The combination of the New bit and the Mod bit indicates an unchanged object when both bits are set to 0. The other bits may be reserved or used for other reasons. Any of the bits could be used as described herein and the IsDIR, New and Mod bits could be associated with other bit positions in the flags field 406. In addition, some of the bits in the flags field may be set once the entry engine determines the state of the object corresponding to the entry being evaluated.

The next field (7 bytes) identifies the next entry after the current directory's last child entry and is used to skip entries in the entry lists as the lists are traversed by the entry engine 306. For example, the next field allows the entry engine to skip certain entries in the previous list and/or the current list when the states of those entries are determined to be deleted or new.

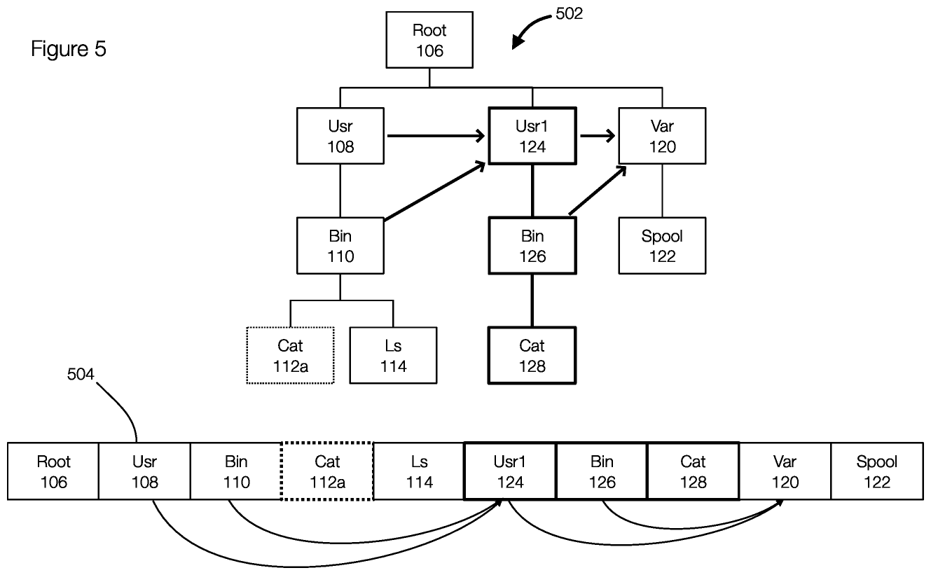

FIG. 5 illustrates the next field in an entry list. As illustrated in FIG. 5, the entry list 504 includes various entries. The entry for Usr 108 has a next field that points to the entry for the usr1 124. This is represented in the structure 502 where the next field for in the entry for the object Usr 108 points to the entry for the object usr1 124.

FIG. 5 thus illustrates which entries in the entry list 504 the next fields point to. For example, Cat 112a and Ls 114 are child objects of/usr/bin. The next field of the entry for the object bin 110 points to the entry for the object usr1 124. As a result, if the child entries (the entries for objects cat 112a and Ls 114) of the entry for bin 110 should be skipped, the next entry is accessed using the next field of the entry for bin 110, which is the entry for usr1 124. FIG. 5 further illustrates that more than one entry in the file 504 may have the same value in their next fields. The next fields of the entries for usr 108 and bin 110 both point to the entry for usr1 124, for example.

If usr1 124 is determined to be new, the process can skip over the children entries for the objects bin 126 and cat 128 of the directory usr1 124 to the entry for var 120 using the next field of the entry for usr1 124. If the usr1 124 is unchanged and the bin 126 is new, the entry for cat 128 can be similarly skipped using the next field of the entry for bin 126.

The last entry for the directory Usr 108 in the structure 502 is the entry for the file Ls 114 and the entry for the file Ls 114 is thus the last child object for the user 108 directory. Thus, the next field of the entry for Usr 108 points to the entry for the usr1 124 in the file 504 after the last child entry for Ls 114. While the entries for the file objects (e.g., Cat 112a and Ls 114) have a next field, their next field may not be used. One reason is that these are the entries that can be skipped in certain circumstances. Otherwise, the entries are processed in order by the entry engine 306.

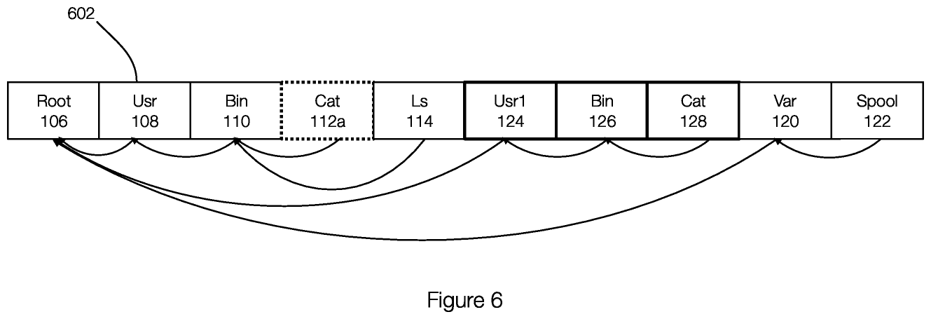

The parent field (7 bytes) is similar to the next field and is used to point to a parent or previous entry in the entry list. FIG. 6 illustrates an example of the parent fields of entries in an entry list. In this example of FIG. 6, the parent field of the entry for Spool 122 points to the entry for var 120. The parent field of the entry for var 120 points to the entry for root 106. The parent fields of the entries for other objects associated with the entry list 602 are similarly illustrated.

The reserved field (1 byte) is reserved and may or may not be used. Thus, some embodiments may provide the reserved field while other embodiments may omit the reserved field.

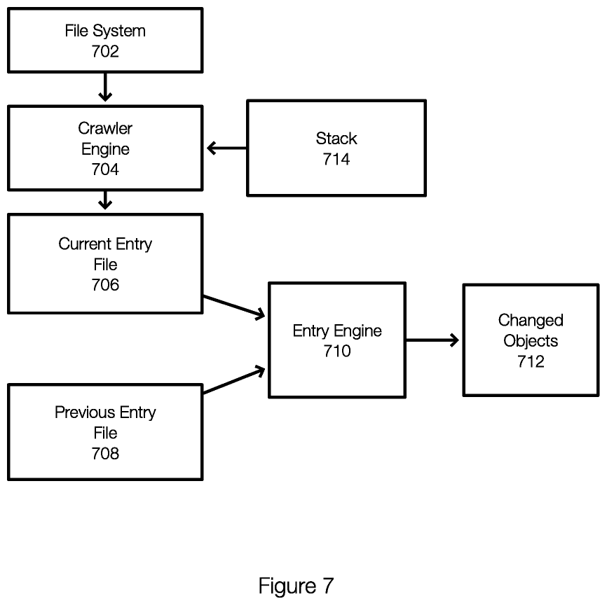

FIG. 7 discloses aspects of a data protection system configured to perform backup operations including identifying changed objects in a file system since a previous backup. In one example, a data protection system may include a crawler engine 704 and an entry engine 710. As shown in FIG. 7, the crawler engine 704 crawls a file system 702. Stated differently, the file system or objects thereof are essentially inputs to the crawler engine 704. As previously stated, the crawler engine 704 may crawl the file system 702 in a deterministic manner.

The crawler engine 704 outputs a current entry file 706, which contains an entry for each object of the file system 702 in one example. The crawler engine 704 may be configured to populate, where possible, the fields in each entry for each object. In one example, the crawler engine 704 may read object metadata and populate the fields in the entries of the entry file 706. This may include generating the OHash value for the OHash field. The crawler engine 704 does not typically generate the CHash of the object.

When generating the entry, the new and modified bits in the flags field are set to 0. As a result, the default status of all objects in the current entry file 706 when generated by the crawler engine 704 is unchanged. Thus, the current entry file 706 generated or output by the crawler engine 704 is prepared for the entry engine 710.

As part of this process, the previous entry file 708 is retrieved. Thus, both the current entry file 706 and the previous entry file 708 are input to the entry engine 710. By comparing entries in the files 706 and 708, the entry engine 710 can identify changed objects 712 the files or objects that have been modified, deleted, or added to the file system 702 since a previous backup of the file system 702. The changed objects 712 (e.g., the new and modified files or objects) can then be backed up as necessary by the data protection system.

The crawler engine 704 may use a stack 714 while crawling the file system 702. In one example, the stacks 714 may include a linked list. The stack 714 allows the crawler engine 704 to at least populate next fields and parent fields of the entries in the current entry file 706.

In one example, once the crawler engine 704 begins accessing the child objects of a directory, the entry of the parent directory with the location of the entry list are pushed onto the stack 714. Once the crawler engine 704 ends accessing all of the child objects, the top entry (or the traversed parent directory) is popped or removed from the stack.

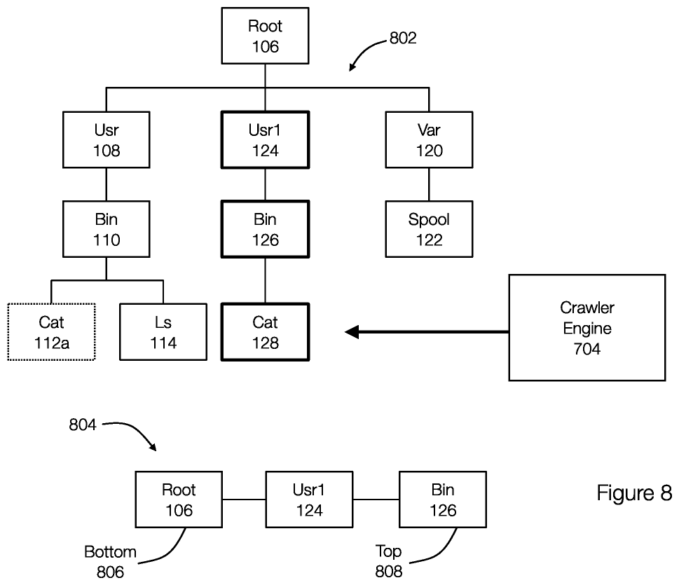

FIG. 8 discloses aspects of a stack associated with a crawler engine that is crawling a file system. FIG. 8 illustrates that the crawler engine 704 is currently accessing the object cat 128. The crawler engine 704 also maintains a stack 804, which includes entries for the objects root 106, usr1 124 and bin 126. The top 808 of the stack is the entry for the bin 126 and the bottom 806 of the stack 804 is the entry for the root 106.

The stack 804 may be used to populate the fields of the entries associated with the objects in the file system 802. For example, the crawler engine 704 is currently accessing the object cat 128. The top 808 entry or element of the stack, which corresponds to the parent object bin 126 of the current object cat 128 being accessed by the crawler engine 704, is used to fill the parent field of the entry in the entry list for cat 128. Thus, the entry for cat 128 is created, added to the entry list or file and the parent field is set to the location of the entry in the entry file for bin 128.

FIG. 8 also illustrates that the crawler engine 704 has reached the last child object in the usr1 124 directory. When the crawler engine 704 is beginning to access a new directory and ending access to the current directory, one or more elements or entries of the stack 804 will be popped or removed from the stack 804. The crawler engine 704 fills the next field for each of the entries in the entry list associated with the elements being popped with a location of the new directory entry in the entry file. Thus, the next fields for the entries for the objects bin 126 and usr1 124 point to the entry in the entry list for var 120.

In other words, once the crawler engine 704 accesses the object cat 128, the entry bin 126 and the entry usr1 124 in the stack 804 are popped and their next fields in the entries for the objects bin 126 and usr1 124 are set to the location of the entry for the object var 120. This next fields are illustrated for entries in the entry file 504 in FIG. 5.

The entry engine 710 often works in parallel with the crawler engine 704. In other words, the entries in the entry file 706 can be processed by the entry engine 701 as soon as they are created. The previous entry file 708 already exists and only the current entry file 706 is being generated. Thus, the entry engine 710 can begin using the entries in the entry file 706 as they are created.

The entry engine 710 beings with the first entry pair {PList(root), CList (root)}. With reference to FIGS. 5 and 7, the entry engine 710 accesses the previous entry file 708 (which is stored on disk for example) and the entry file 706 created by the crawler engine 704, which may be resident in memory or disk. When the entry engine works on an entry pair, a dedicated stack is built using the parent fields in one example.

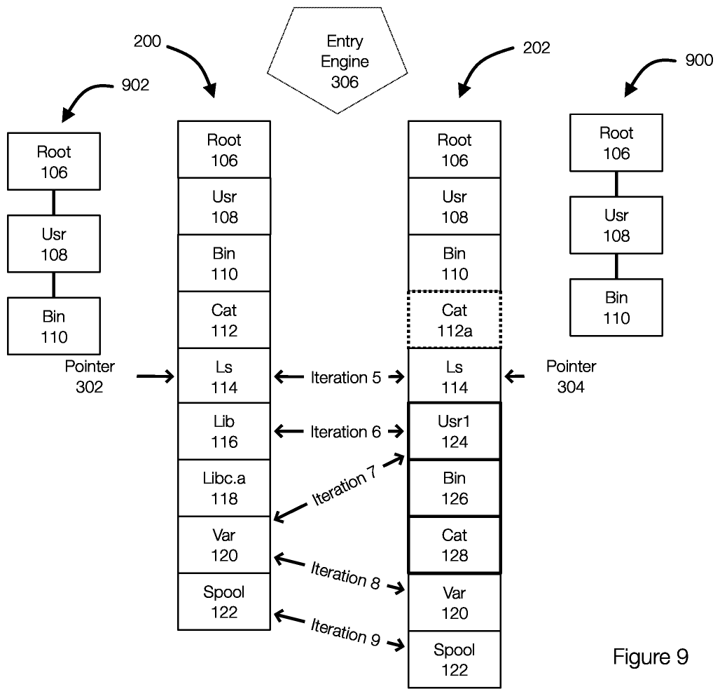

FIG. 9 illustrates is an altered view of FIG. 3 and is changed to disclose aspects of a working pair. In this example, the entry engine 306 is performing iteration 5. The pointers 302 and 304 point to the entries for the object Ls 114 in the files 200 and 202. The working pair is {PList(Ls 114), CList(Ls 114)}. In this example, the stack 900 for the current backup entry in the entry list 202 is illustrated as stack 900. The stack 902 is similar and is associated with the entry list 200.

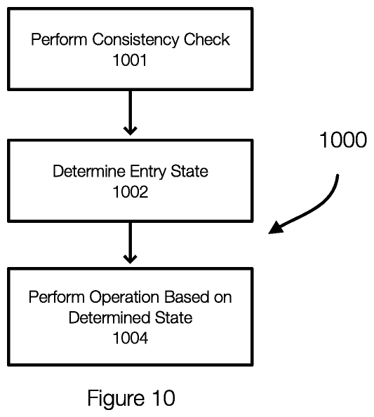

FIG. 10 discloses aspects of a method of entry checking or state determining. The method 1000 is performed for each iteration. The method begins by determining 1002 an entry state for the entry in the current entry file. The entry engine then performs 1004 an operation based on the state determined in 1000.

In one example, the method 1000 may also perform 1001 a requisite check for backup consistency. This validates the existence of the previous backup on the backup storage server. If the previous backup does not exist, the entry engine may find the latest backup on the backup storage server and restores the entry file and name file associated with the latest backup.

Determining 1002 the entry state can be performed by comparing entries in the current entry list and the previous entry list. The comparison can determine whether the current backup entry is unchanged, modified, new, or deleted.

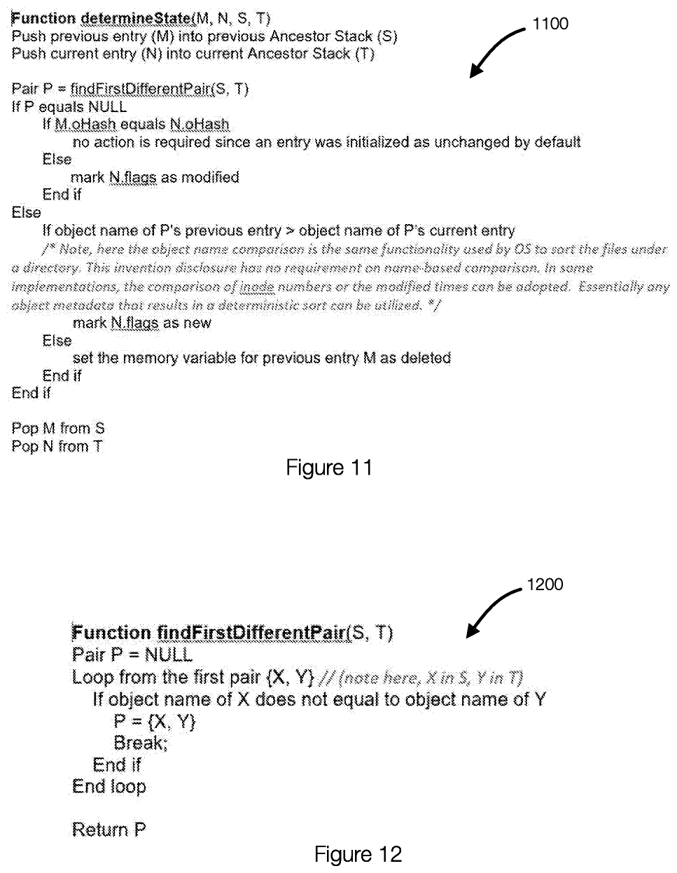

FIG. 11 illustrates an example of pseudocode for determining 1002 a state of an entry in the current entry list. FIG. 12 also an example of pseudocode for determining a state. FIG. 11 illustrates a function determineState(M,N, S,T) 1100 and FIG. 12 illustrates a function findFirstDifferentPairs(S,T).

In this example, M and N refer to pointers to entries or entries in, respectively, the previous entry file (M) and the current entry file (N). In this example, S and T refer to a previous stack (S) and a current stack (T). In the function 1200, if all entry pairs in the stacks S and T have or are associated with the same object names, the entry pair {M,N} represent the same object between the previous backup and the current backup. In this example, the first different pair is empty.

In the function 1100, the comparisons of the OHash from the previous entry list and the current entry list are used to determine whether the current entry is modified or not.

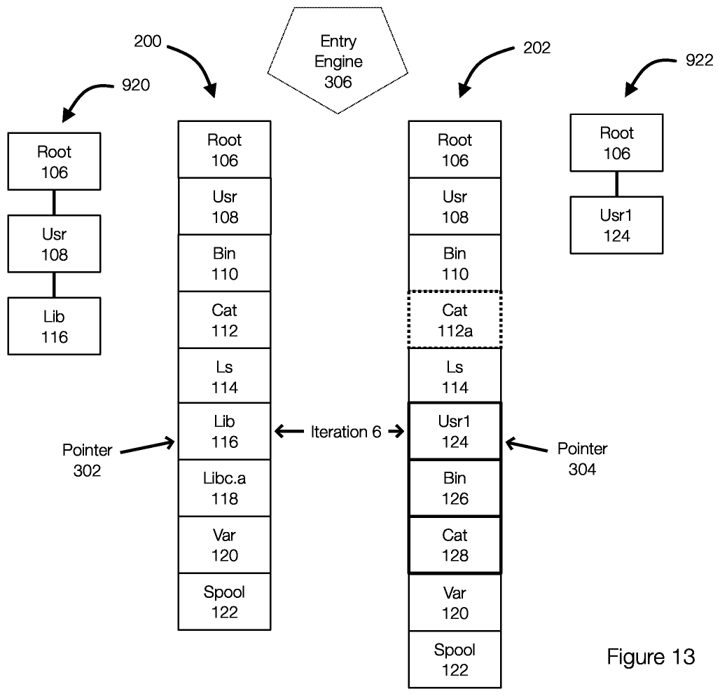

FIG. 13 further illustrates a process for determining an entry state. In iteration 6 shown in FIG. 13 (see also at least FIG. 3), the previous list 200 is associated with a previous stack 920 and the current list is associated with a current stack 922. As previously stated, the contents of the stacks 920 and 922 changes as entries are popped on/off of the stack. The stacks 920 and 922 correspond to the contents of the stack at the time of iteration 6. As illustrated, the pervious stack is root—Usr—Lib and the current stack 922 is root—Usr1.

When the function findfirstDifferentPair(S,T) is executed, the function checks the first pair {X=“/”, Y=“/”}. Because X and Y are equal, then function continues to check the next pair {X=“/usr”, Y=“/usr1”}. The function determines that X and Y are different and that this is the first different pair or first differential pair for this iteration. As a result, the evaluation performed by the entry engine determines where X and Y are different (this is the first different pair). The function returns the pair {X=“/usr”, Y=“/usr1”} is returned.

The state of the entry is then determined using the function determineState( ). In the function determineState( ), the returned pair {X=“/usr”, Y=“/usr1”} is used to determine the state. In one example, the function determines either a newly created object in the file system to be included in the current backup or a deleted object relative to the previous backup. In other words, the first different pair can be used to determine whether an object has been deleted or is newly added with respect to the current backup.

The state can be determined for various reasons that are related to the manner in which the previous list or file 200 and the current list or file 202 are generated (e.g., deterministically. There are three conditions that are true.

Condition 1:
First, the entries with the same direct parent are spread out in ascendant order of entry identifiers in the backup entries. For example, in current backup list 200, “/usr”, “/usr1” and “/var” have the same direct parent (“I”). Plus, these 3 entries are spread out and keep their relative order in the entry file 202 (their indexes in the file 202 (e.g., an array) are: 1, 5, 8, assume the index is started from 0 in an array). This condition is always true since crawler traverses the filesystem in a depth-first manner in this example.

Condition 2:
Another condition is where one entry (A) and the other entry (B) are siblings (with the same direct parent):
if A is in front of B (in backup entry list), then the entries underneath A are in front of the entries underneath B;
if B is in front of A (in backup entry list), then the entries underneath B are in front of the entries underneath A.
For example, in current backup entries, the entry “/usr” (where “I” is root in the Figures) is in front of the entry “/usr1”, all of the entries underneath “/usr” (“/usr/bin”, “/usr/bin/cat” and “/usr/bin/ls”) are in front of all entries underneath “/usr1” (“/usr1/bin” and “/usr1/bin/cat”). This condition is always true because the depth-first traversal always goes through an object and then through objects underneath that object. When all objects underneath an object are completed, the traversal goes through other siblings of that object. Entries that are appended to the entry file thus keep the same order or the same relative order.

Condition 3:
The entries which are in front of the current pair being examined in iteration 6 ({M=“/usr/lib”, N=“/usr1”} in this example) are either determined (as unchanged or modified) or skipped over (entries with their underneath entries are determined as deleted or newly created). This condition is always true since the determining algorithm starts from the root entries, and the succeeding iteration will not re-determine the accessed entry pairs.

Returning to the function findFirstDifferentPair, the pair {X=“/usr”, Y=“/usr1”} is returned.

Assume, in this example that M (“/usr/lib”) were not deleted between the backups (this first assumption is false). Based on the first assumption it can be deduced that there must be an entry “/usr/lib” in front of or behind N (“/usr1”) in current backup entry list.

Assume, as a second assumption that “/usr/lib” is in front of “/usr1” in current backup entry list. The second assumption breaks the third condition. If this second assumption were true, it could be determined that “/usr/lib” in both that previous backup entry list 200 and the current backup entry list 202 shall always be prior to determining “/usr1”. In other words, if the second assumption were true, the M “/usr/lib” in previous backup entry list must have been determined in previous iteration and the entry pointer will not point to M in current iteration. This proves the second assumption is not true.

The deterministic order of entries in the entry lists or files is what allows the algorithm to determine that, if “/usr/lib” existed in the current backup, it would have occurred in the entry list before “/usr1”. As a result, when the entry engine sees the “/usr1” entry in the current backup or the current entry list, the entry engine is able to determine that object “/usr/lib” (which was a directory in the previous backup) has been deleted.

In order to defend the first assumption, assume, as a third assumption, that “/usr/lib” is behind “/usr1” in current backup entry list 202. In this case, the third assumption breaks the second condition: all underneath entries of “/usr” shall be in front of entry “/usr1” in the current backup entry list 202.

Based on this analysis, it can be determined that if X<Y, M (underneath of X) has been deleted between backups.

With the same logic, it can be determined that if X>Y, then N (underneath of Y) is newly created between backups. This allows the state of the objects associated with the entries being evaluated to be determined.

A similar analysis can be performed, when necessary for each iteration.

Once the entry state is determined 1002 in FIG. 10, an operation is performed 1004 based on the determined state.

The operations are performed as follows. If the current entry is unchanged, then the CHash value from the previous backup entry is copied to the CHash field of the current backup entry. In this way, the value from previous entry is re-used to build the current entry list. Then, both entry pointers (previous and current) are moved to the successive entries in the previous and current entry lists as shown by iterations 1, 2, 3, 5, 8, and 9.

If current entry is modified, then the modified bit in the flags field of the current backup entry is set to 1. CHash may be left empty. Because the file content has been modified, CHash may be recalculated at a later time. In this operation, both entry pointers (previous and current) are moved to the successive entries (e.g., iteration 4).

If current entry is newly added, the new bit in the flags field of the current backup entry is set or marked as 1. The current entry pointer is moved to the entry addressed by its next field (skipping over the new entries) and the previous entry pointer is not moved. In addition, the skipped entries are marked as new (see the example of iteration 7 to iteration 8).

If previous entry was deleted, the previous entry pointer is moved to the entry addressed by next field (skipping over the deleted entries) and the current backup entry pointer is left untouched and not moved (e.g., iteration 6 to iteration 7).

A backup client or a data protection system, equipped with crawler engine and an entry engine, can work with, by way of example only, a content-addressed storage server with front-end deduplication (e.g., DELL AVAMAR) as well as a back-end deduplication storage server (e.g., DELL DataDomain). Embodiments may be used with PowerProtect Data Manager (PPDM) and DDBoost.

Embodiments of the invention organize entries in a filesystem using a file layout and an entry structure. These layouts or structures store a knowledge of the tree layout of the protected filesystem using the parent field and the next field. Using a stack, the crawler engine can generate the entry list or file in an effective manner.

The entry engine can identify the changed object with fine granularity by reading the entries in the entry files or lists sequentially and at the same time (reading both the previous and current entry files). As a result, this helps conserve memory consumption despite the scale of the filesystem to be protected.

The entry engine is also able to skip over entries and determine whether the associated children (objects underneath the entry) are newly added or recently deleted. This improves the efficiency of the entry engine.

Embodiments of the invention are also independent from the operating system, file systems, and backup storage and can be integrated into multiple data protection systems to aid in determining which objects have changed since a previous backup.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations. Such operations may include, but are not limited to, crawling operations, entry comparison operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

It is noted with respect to the example methods discussed herein that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Following are some further example embodiments of the invention. These are presented only by way of example and are not intended to limit the scope of the invention in any way.

Embodiment 1. A method, comprising: for a current entry list and a previous entry list that each contain a plurality of entries, each entry corresponding to an object, performing an entry checking operation by: determining an entry state of an entry in the current entry list by evaluating the entry in the current entry list with an entry in the previous entry list, wherein the current entry list is associated with a current backup of a filesystem and the previous entry list is associated with a previous backup of the filesystem, and performing an operation on the entry based on the entry state, and performing a data protection operation on objects that are changed from the previous backup relative to the current backup based on the entry checking operation.

Embodiment 2. The method of embodiment 1, further comprising crawling the file system to generate the current entry list in a deterministic manner, wherein the previous entry list was previously generated in the deterministic manner.

Embodiment 3. The method of embodiment 1 and/or 2, wherein the deterministic manner is depth-first.

Embodiment 4. The method of embodiment 1, 2, and/or 3, further comprising generating a current stack used in the entry checking operation and associated with the current entry list and generating a previous stack associated with the previous entry list.

Embodiment 5. The method of embodiment 1, 2, 3, and/or 4, further comprising finding a first differential pair for an entry and inferring, from the first differential pair, whether objects have been added to the file system or objects have been deleted from the file system.

Embodiment 6. The method of embodiment 1, 2, 3, 4, and/or 5, further comprising skipping entries in the previous entry list associated with deleted objects and skipping entries in the current entry list associated with newly added objects.

Embodiment 7. The method of embodiment 1, 2, 3, 4, 5, and/or 6, further comprising finding the first differential pair based on a comparison of the previous stack and the current stack.

Embodiment 8. The method of embodiment 1, 2, 3, 4, 5, 6, and/or 7, further comprising populating fields in the entries of the current entry list, the fields including a hash of a combination of object metadata, a next field, a flag field, a parent field.

Embodiment 9. The method of embodiment 1, 2, 3, 4, 5, 6, 7, and/or 8, further comprising generating the hash from two or more of an object full path, an object size, a modify time.

Embodiment 10. The method of embodiment 1, 2, 3, 4, 5, 6, 7, and/or 9, further comprising performing iterations by the entry checking operation, wherein each iteration compares and entry from the previous entry list and an entry from the current entry list.

Embodiment 11. The method of embodiment 1, 2, 3, 4, 5, 6, 7, 8, 9, and/or 10, wherein the operation is one of: determining that an object for the entry is unchanged, wherein a previous hash of the object's content is added to the entry and a previous pointer for the previous entry list and a current pointer for current entry list are both are advanced, determining that the object for the entry is modified, wherein a flag is set in a flag field and the current pointer and the previous pointer are advanced, determining that the object for the entry is new, wherein a flag is set in the flag field, the current pointer is moved to skip over children entries, and the previous pointer is not advanced, or determining that an object has been deleted, wherein the previous pointer is moved using the next field to skip entries associated with deleted objects and the current pointer is not moved.

Embodiment 12. A method for performing any of the operations, methods, or processes, or any portion of any of these, disclosed herein or in embodiments 1-11.

Embodiment 13. A non-transitory storage medium having stored therein instructions that are executable by one or more hardware processors to perform operations comprising the operations of any one or more of embodiments 1-12

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, herein and/or elsewhere herein, may take the form of, or include, or be implemented on, or hosted by, a physical computing device. As well, where any of the aforementioned elements comprise or consist of a virtual machine (VM) or container, that VM may constitute a virtualization of any combination of the physical components disclosed herein.

In one example, the physical computing device includes a memory which may include one, some, or all, of random access memory (RAM), non-volatile memory (NVM) such as NVRAM for example, read-only memory (ROM), and persistent memory, one or more hardware processors, non-transitory storage media, UI device, and data storage. One or more of the memory components of the physical computing device may take the form of solid state device (SSD) storage. As well, one or more applications may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
for a current entry list and a previous entry list that each contain a plurality of entries, each entry corresponding to an object in a system, performing an entry checking operation by comparing pairs of entries in the current entry list and the previous entry list, wherein each comparison includes:
determining an entry state of an entry in the current entry list by evaluating the entry in the current entry list with an entry in the previous entry list, wherein the current entry list is associated with a current backup of a filesystem and the previous entry list is associated with a previous backup of the filesystem; and
performing an operation on the entry based on the entry state;
finding a first differential pair that includes an entry from the current entry list and an entry from the previous entry list and inferring, from the first differential pair, whether objects have been added to or deleted from the system; and
performing a data protection operation on objects that are changed from the previous backup relative to the current backup based on the entry checking operation.

2. The method of claim 1, further comprising crawling the file system to generate the current entry list in a deterministic manner, wherein the previous entry list was previously generated in the deterministic manner.

3. The method of claim 2, wherein the deterministic manner is depth-first.

4. The method of claim 1, further comprising generating a current stack used in the entry checking operation and associated with the current entry list and generating a previous stack associated with the previous entry list.

5. The method of claim 1, wherein the system comprises a file system.

6. The method of claim 1, further comprising skipping entries in the previous entry list associated with deleted objects and skipping entries in the current entry list associated with newly added objects.

7. The method of claim 4, further comprising finding the first differential pair based on a comparison of the previous stack and the current stack.

8. The method of claim 1, further comprising populating fields in the entries of the current entry list, the fields including a hash of a combination of object metadata, a next field, a flag field, a parent field.

9. The method of claim 8, further comprising generating the hash from two or more of an object full path, an object size, a modify time.

10. The method of claim 1, further comprising performing iterations by the entry checking operation, wherein each iteration compares and entry from the previous entry list and an entry from the current entry list.

11. The method of claim 10, wherein the operation is one of:
determining that an object for the entry is unchanged, wherein a previous hash of the object's content is added to the entry and a previous pointer for the previous entry list and a current pointer for current entry list are both are advanced;
determining that the object for the entry is modified, wherein a flag is set in a flag field and the current pointer and the previous pointer are advanced;
determining that the object for the entry is new, wherein a flag is set in the flag field, the current pointer is moved to skip over children entries, and the previous pointer is not advanced; or
determining that an object has been deleted, wherein the previous pointer is moved using the next field to skip entries associated with deleted objects and the current pointer is not moved.

12. A non-transitory storage medium having stored therein instructions that are executable by one or more hardware processors to perform operations comprising:
for a current entry list and a previous entry list that each contain a plurality of entries, each entry corresponding to an object in a system, performing an entry checking operation by comparing pairs of entries in the current entry list and the previous entry list, wherein each comparison includes:
determining an entry state of an entry in the current entry list by evaluating the entry in the current entry list with an entry in the previous entry list, wherein the current entry list is associated with a current backup of a filesystem and the previous entry list is associated with a previous backup of the filesystem; and
performing an operation on the entry based on the entry state;
finding a first differential pair that includes an entry from the current entry list and an entry from the previous entry list and inferring, from the first differential pair, whether objects have been added to or deleted from the system; and
performing a data protection operation on objects that are changed from the previous backup relative to the current backup based on the entry checking operation.

13. The non-transitory storage medium of claim 12, wherein the system comprises a filesystem, further comprising crawling the file system to generate the current entry list in a deterministic manner, wherein the previous entry list was previously generated in the deterministic manner.

14. The non-transitory storage medium of claim 12, further comprising generating a current stack used in the entry checking operation and associated with the current entry list and generating a previous stack associated with the previous entry list.

15. The non-transitory storage medium of claim 14, further comprising skipping entries in the previous entry list associated with deleted objects and skipping entries in the current entry list associated with newly added objects.

16. The non-transitory storage medium of claim 14, further comprising finding the first differential pair based on a comparison of the previous stack and the current stack.

17. The non-transitory storage medium of claim 12, further comprising populating fields in the entries of the current entry list, the fields including a hash of a combination of object metadata, a next field, a flag field, a parent field.

18. The non-transitory storage medium of claim 17, further comprising generating the hash from two or more of an object full path, an object size, a modify time.

19. The non-transitory storage medium of claim 12, further comprising performing iterations by the entry checking operation, wherein each iteration compares and entry from the previous entry list and an entry from the current entry list.

20. The non-transitory storage medium of claim 19, wherein the operation is one of:
determining that an object for the entry is unchanged, wherein a previous hash of the object's content is added to the entry and a previous pointer for the previous entry list and a current pointer for current entry list are both are advanced;
determining that the object for the entry is modified, wherein a flag is set in a flag field and the current pointer and the previous pointer are advanced;
determining that the object for the entry is new, wherein a flag is set in the flag field, the current pointer is moved to skip over children entries, and the previous pointer is not advanced; or
determining that an object has been deleted, wherein the previous pointer is moved using the next field to skip entries associated with deleted objects and the current pointer is not moved.
